(19) United States
(12) Patent Application Publication
(10) Pub. No.: US 2014/0305770 A1
(43) Pub. Date: Oct. 16, 2014

(54) Transport member for transporting strip-like elements to be treated in a bath

(71) Applicant: Meco Equipment Engineers B.V., DRUNEN (NL)

(72) Inventor: Peter Jacobus Gerardus Loermans, Bergharen (NL)

(21) Appl. No.: 14/357,924

(22) PCT Filed: Nov. 15, 2012
(86) PCT No.: PCT/NL2012/050806

§ 371 Date: May 13, 2014

(30) Foreign Application Priority Data
Nov. 18, 2011 (NL) 2007816

(51) Int. Cl. B65G 17/12

(52) U.S. Cl. CPC B65G 17/12
USPC 198/470.1

(57) ABSTRACT

The present invention provides a transport member for transporting strip-like elements to be treated in a bath. The transport member is provided with a horizontally oriented endless carrier belt with resilient wire-like clamping members attached thereto by means of their own resilience for the purpose of clamping the strip-like elements at the position of wire ends of the clamping members. Wire ends of adjacent clamping members are provided opposite each other for clamping the strip-like elements therebetween.

The present invention relates to a transport member for transporting strip-like elements to be treated in a bath, provided with a horizontally oriented endless carrier belt with resilient wire-like clamping members attached thereto by means of their own resilience for the purpose of clamping the strip-like elements at the position of wire ends of the clamping members.

Such a transport member is specified in the American patent application US 2006/0081445 A1. Such transport members are typically applied in electrochemical production processes for producing electronic components wherein the bath is filled with an electrolytic solution. The treatment relates in general to the growing of a layer on one or both sides of the strip-like elements or, conversely, removing one or a number of layers. During application the strip-like elements to be treated are clamped close to the upper edge thereof at the position of the wire ends of the clamping members. The strip-like elements are then substantially always fully immersed in the liquid in the bath so as to undergo the relevant treatment. It is then unavoidable here that a part of the clamping members and a part of the conveyor belt, i.e. those parts extending within the height of the strip-like element, are also placed in the liquid and consequently also subjected to the treatment. This has the result that said parts must be at least regularly cleaned, for instance flushed and stripped. A further consequence of the complete immersion is that masking occurs due to the clamping of the strip-like element: parts of the strip-like element covered by the carrier belt or the clamping member will not undergo the treatment in the bath, or will only do so to lesser extent. This is not a problem if said parts do not form a final part of the end product or if it is not a requirement that said parts in the end product should undergo the treatment. For some end products, and therefore for the strip-like elements which can be deemed as semi-products, it is however the case that it is strongly recommended technically that the whole surface of one or both sides of the strip-like element undergoes the treatment. It is known by way of compromise that extremely small parts of the surface of the strip-like element are then made “available” to allow engagement at that position by the clamping members. It has been found difficult in practice to enable engagement of these small engaging portions with sufficient accuracy. This entails the risk of parts of the surface adjacent to the engaging portions also being masked by the clamping members. As will be apparent from the foregoing, this is undesirable.

The invention now has for its object to reduce the above stated risk. The invention has the more specific object of making it possible for the greatest possible part, in other words substantially the whole surface of a strip-like element, to be subjected to the relevant treatment despite being suspended using the clamping members and complete immersion in a treatment liquid in a bath. Wire ends of adjacent clamping members are for this purpose provided opposite each other for clamping the strip-like elements therebetween. Where in the prior art clamping of the strip-like elements takes place between a wire end and the carrier belt, in the present invention clamping takes place between two wire ends. The surface of the strip-like element which is hereby actually masked because of the clamping is hereby reduced, whereby either a greater tolerance can be allowed in respect of the accuracy with which a strip-like element is engaged or a smaller part of the surface of the strip-like element can be made “available” for engagement while accuracy remains the same.

In order to achieve that a smaller part of the carrier belt, or even in the extreme case no part of the carrier belt at all, makes contact with the liquid in the bath during complete immersion of a strip-like element in the liquid in the bath, it may be possible to provide the carrier belt, at the lengthwise positions thereof where wire ends of adjacent clamping members are provided opposite each other, with downward protruding support parts against which one of the clamping members lies due to its own resilience. At least achieved in such an embodiment is that, because of the absence of material of the carrier belt between the downward protruding support parts thereof, masking by the carrier belt occurs between the downward protruding support parts.

The application of downward protruding support parts can also be advantageous in prior art support members. This will then relate to a transport member for transporting strip-like elements to be treated in a bath, provided with a horizontally oriented endless carrier belt with resilient wire-like clamping members attached thereto by means of their own resilience for the purpose of clamping the strip-like elements at the position of wire ends of the clamping members, wherein the carrier belt is provided with downward protruding support parts at the lengthwise positions thereof where the wire ends are provided for the purpose of clamping the strip-like elements.

A structurally favourable embodiment is obtained when one wire end of the adjacent clamping members lies due to its own resilience against the carrier belt and the wire end of the other of the adjacent clamping members, due to its own resilience, is biased in the direction of the one wire end away from the side of the one wire end remote from the carrier belt. In such an embodiment of a transport member a stable positioning of the wire ends, and thereby a reliable clamping, can be achieved.

In order to make the masking effect as small as possible it is possible for the clamping member with the wire end which lies against the carrier belt to be manufactured from wire with a smaller diameter than the diameter of the wire from which the other clamping member biased in the direction of the one clamping member is manufactured. The diameter of the wire from which the other clamping member is manufactured must be able to generate the required clamping force.

When the wire ends lying opposite each other extend under the carrier belt, the advantage is gained that clamping of the strip-like elements can take place wholly below the carrier belt. Complete immersion of the strip-like elements in the liquid in a bath does not then necessarily entail a part of the carrier belt also being immersed. It may as a result be less necessary to clean the carrier belt following treatment of a strip-like element. In addition, the advantage is gained that it is thus possible to grip a strip-like element with an engaging part provided at a certain distance below the upper edge of the strip-like element. Engagement is moreover also possible between thickened parts of the strip-like element, such as can for instance be formed by plastic protective layers encapsulating determined parts of the strip-like element.

In order to ensure that, despite the fact that clamping members are provided adjacently of each other, wire ends of adjacent clamping members are nevertheless provided opposite each other, it is advantageous that the wire from which one of the two adjacent clamping members is manufactured runs between the wire end thereof and a spiral-shaped part of the clamping member partly in the longitudinal direction of the carrier belt.

Although the invention is not only applicable in this way, it can be applied in particularly favourable manner when at least one of the clamping members is in conductive contact with an electrical voltage source for applying an electrical voltage to the strip-like elements. In addition to being used to clamp the strip-like elements, said clamping members are thus also used to supply the current required for an electrolytic process in the bath.

In order to enhance a reliable clamping, wire ends of adjacent clamping members provided opposite each other can enclose a downward directed angle with each other, at least in the situation where a strip-like element is not being clamped and the wire ends lie against each other in the area above the contact location. This prevents an upward directed angle occurring because of the thickness of the strip-like element, thereby creating the risk of the strip-like element sliding downward between the clamping wire ends. In the case clamping of the strip-like element takes place at the position of an opening in the strip-like element, just on the upper side thereof, the wire ends can moreover protrude partially into this opening because of the angle.

The optimum angle will depend on the thickness of the strip-like elements to be treated, but it will usually be favourable in practice that, if a strip-like element is not being clamped and the wire ends lie against each other in the area above the contact location, the size of the angle lies between 3 degrees and 30 degrees, more preferably between 5 degrees and 25 degrees.

The invention will be further elucidated hereinbelow on the basis of the description of three embodiments with reference to the following figures:

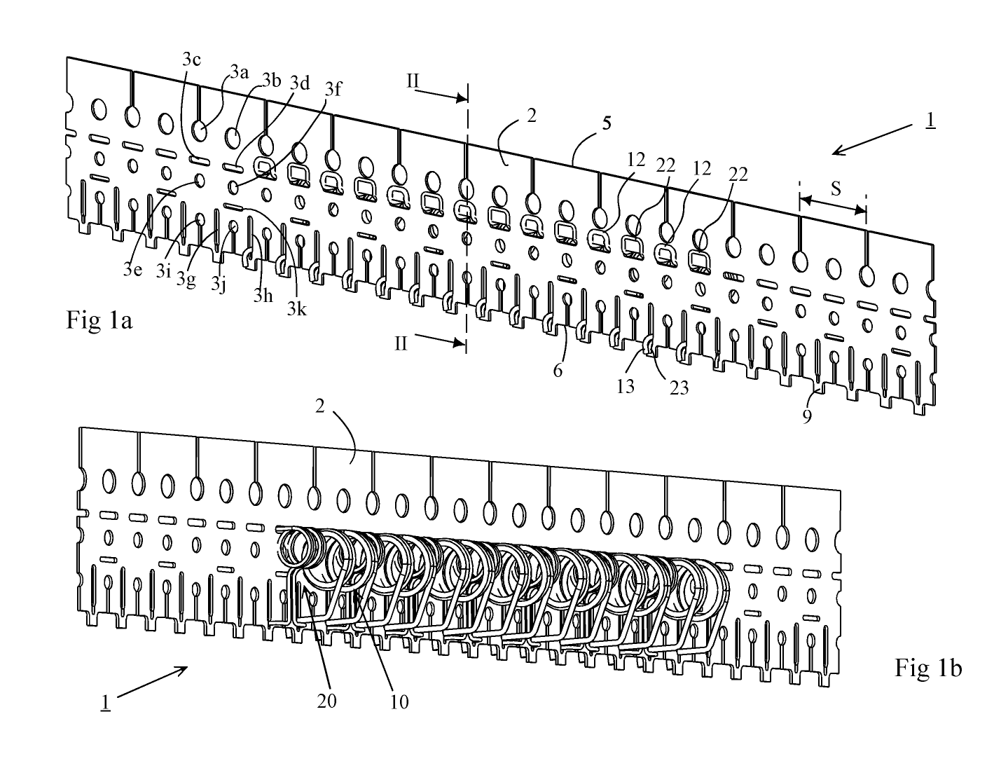

FIGS. 1a and 1b show two different perspective views of (part of) a transport member according to the invention;

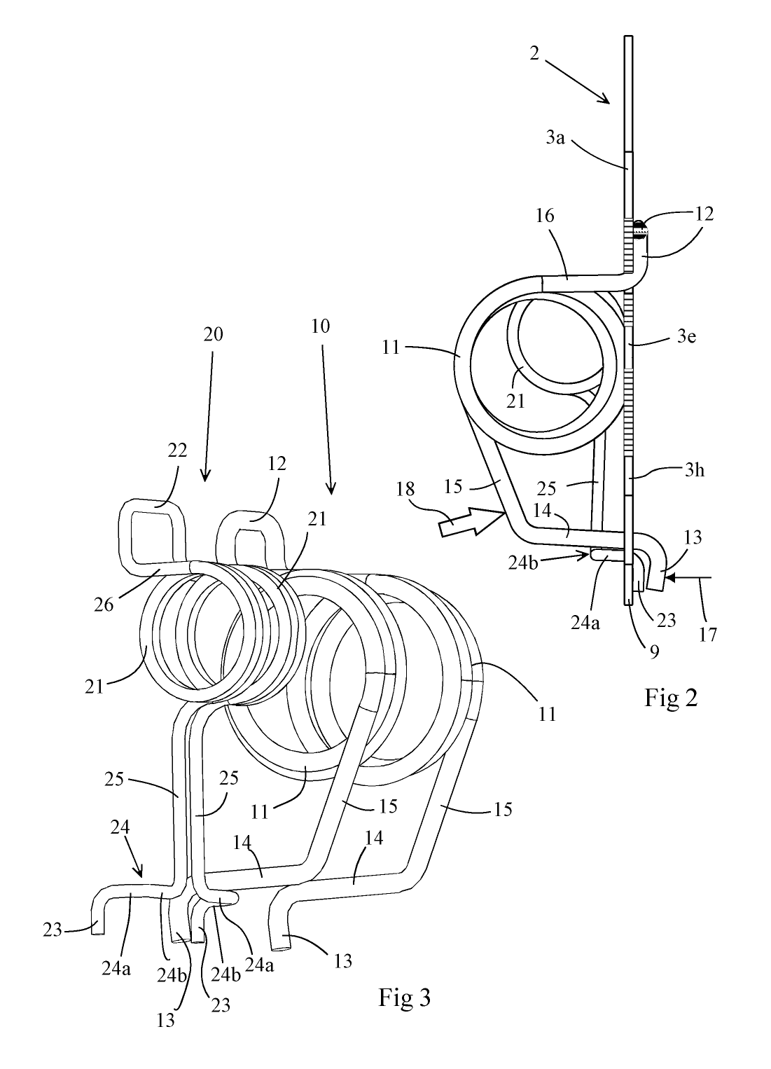

FIG. 2 shows vertical cross-section II-II of FIG. 1a;

FIG. 3 shows a pair of two adjacent clamping members as applied in plurality in the transport member according to FIGS. 1a and 1b;

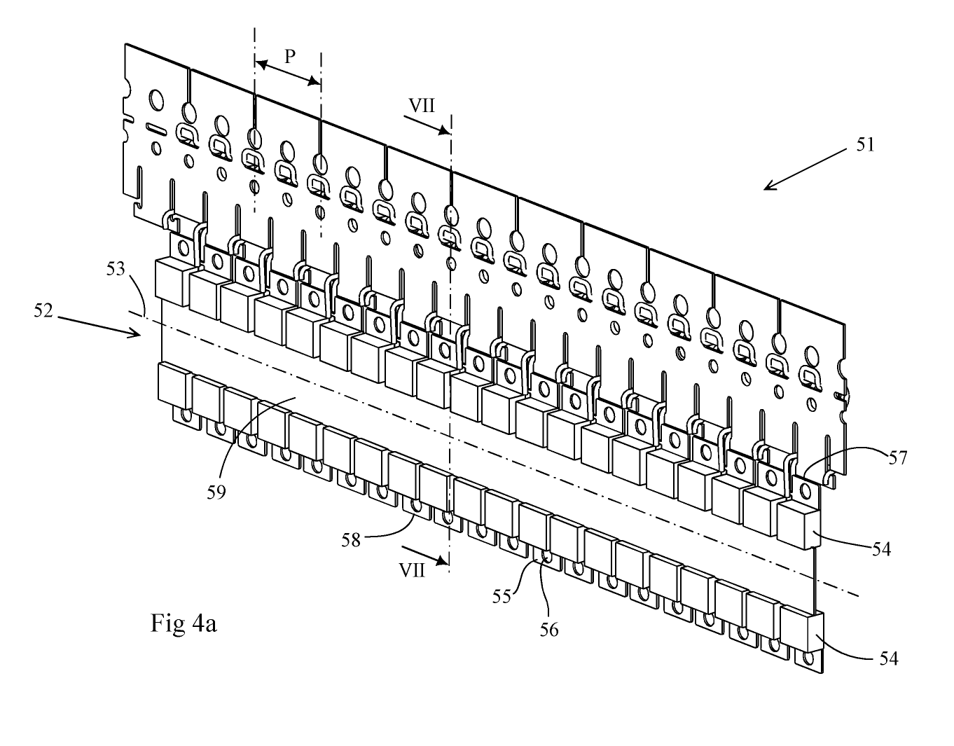

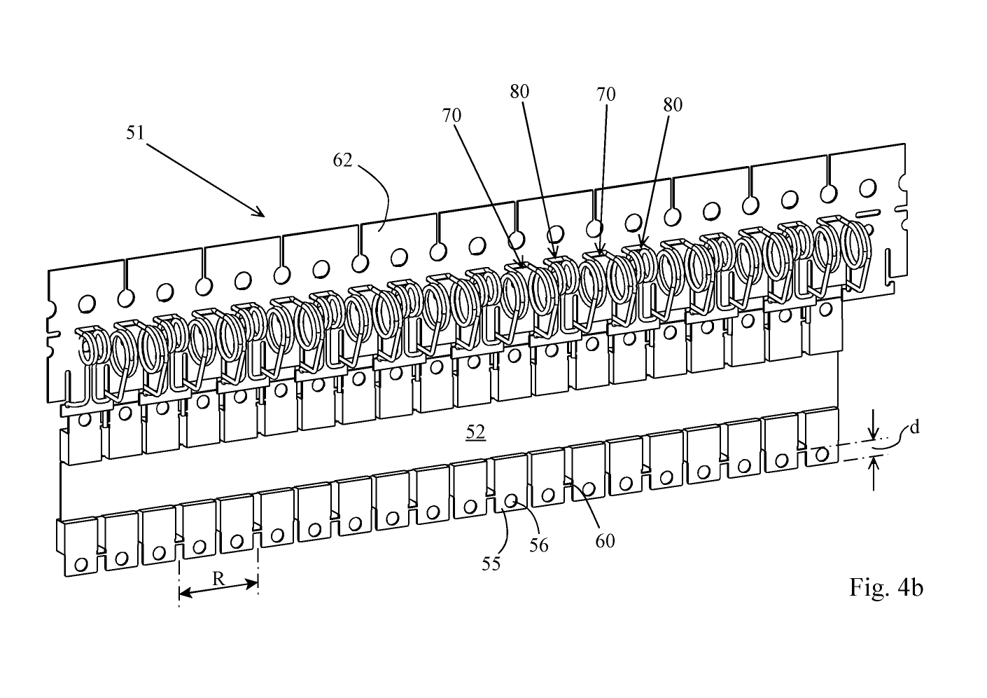

FIGS. 4a and 4b show two different perspective views of a second embodiment of a transport member according to the invention, including a strip-like element to be treated;

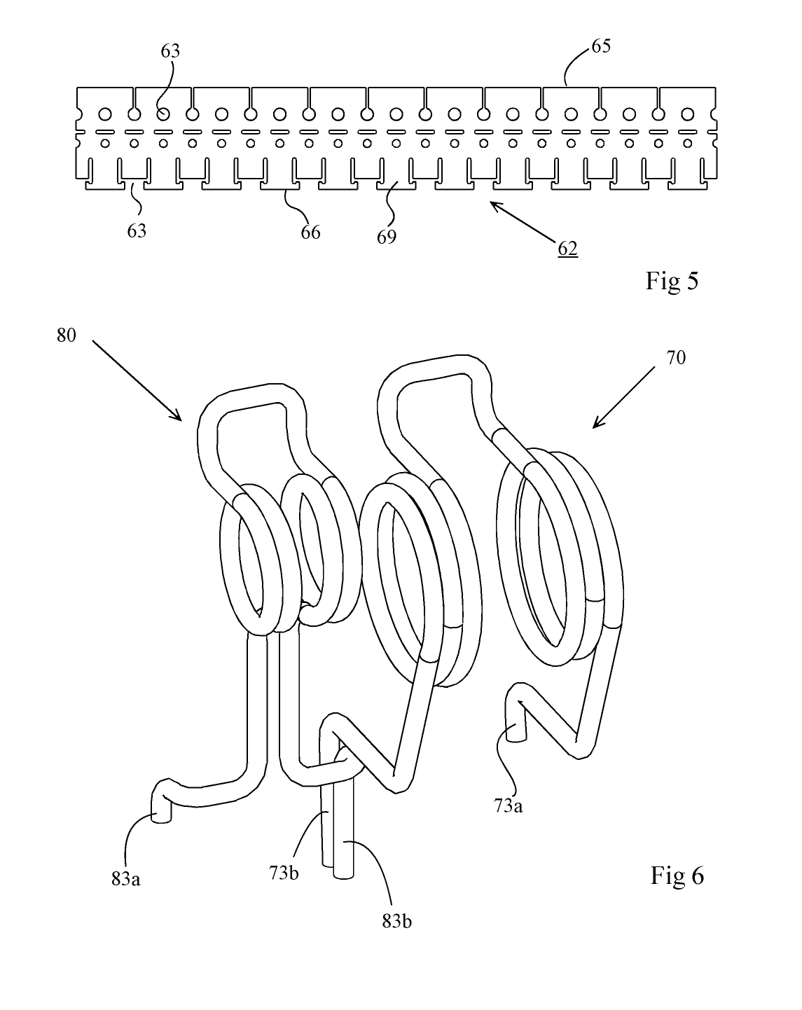

FIG. 5 shows a front view of the carrier belt of the transport member according to FIGS. 4a and 4b;

FIG. 6 shows a pair of two adjacent clamping members as applied in the transport member according to FIGS. 4a and 4b;

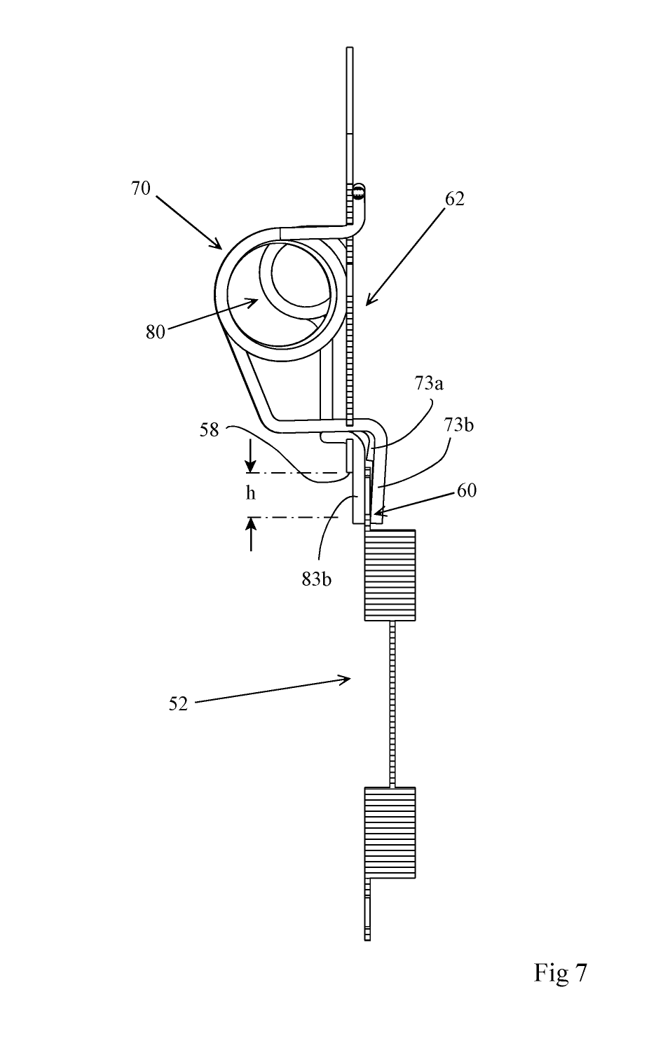

FIG. 7 shows vertical cross-section VII-VII of FIG. 4a;

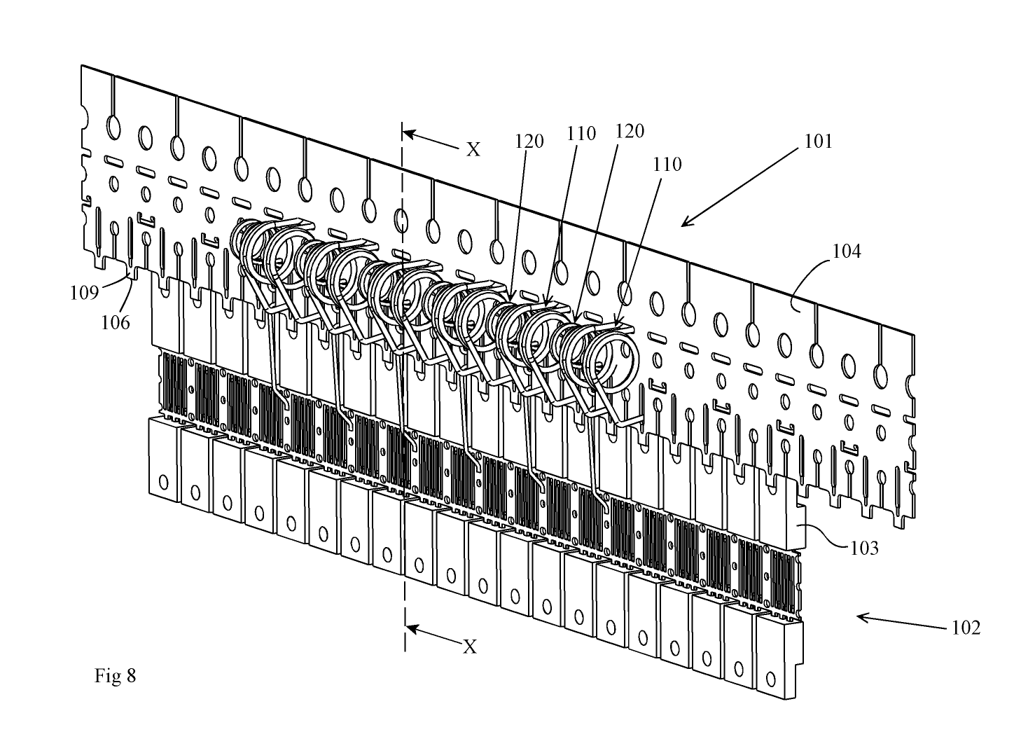

FIG. 8 shows a perspective view of a third embodiment of a transport member, including strip-like element;

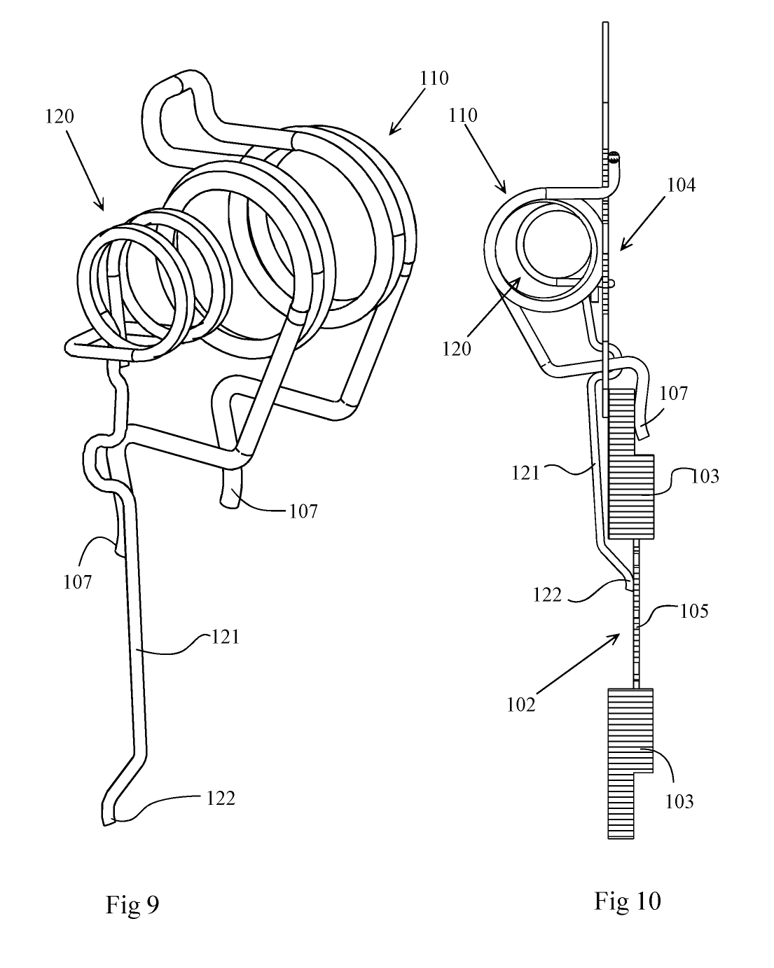

FIG. 9 shows a perspective view of a pair of a clamping member and a contact number as applied in plurality in the transport member according to FIG. 8;

FIG. 10 shows vertical cross-section according to X-X in FIG. 8.

FIGS. 1a and 1b show a part of a transport member 1. The transport member 1 comprises an endless conveyor belt 2, which, as known to the skilled person, is passed over two pulleys. For the sake of completeness reference is made in this respect by way of background information to FIG. 3 of EP 382 283 A1 which shows how a transport number 10 is passed over guide wheels 8, 9. Using the clamping members 14 which are attached to the carrier belt 10 the strip-like elements 1 are suspended from the transport member, after which the strip-like elements 1 are guided through a treatment liquid in the bath 6. Particular consideration will be given below to those aspects which distinguish the present invention from the prior art.

The carrier belt 2 is manufactured from an electrically conductive material, preferably metal, and is provided with a regular pattern of openings 3a to 3k, which openings do or do not connect to the upper edge 5 or the lower edge 6 of the carrier belt 2. Said pattern has a pitch of size S. Downward protruding support elements 9 are provided in the lower edge 6.

The transport member 1 further comprises clamping members (see also FIG. 3). These clamping members are wire springs in two different embodiments which are attached alternately by means of their own resilience to the carrier belt 2 over the full length of the carrier belt. In FIGS. 1a and 1b the clamping members are shown for the sake of clarity over only a part of the length of the carrier belt 2.

The clamping member 10 takes a mirror-symmetrical form relative to a vertical plane of symmetry. The clamping member 10 comprises a spiral-shaped winding 11 on each side of this plane of symmetry. On the upper side of the clamping member 10 the windings 11 are connected to each other via the U-shaped connecting part 12 through which the plane of symmetry extends. On the underside of the windings 11 each clamping member 10 comprises two downward directed wire ends 13 which are connected via lying parts 14 and standing parts 15 to an associated winding 11. The connecting part 12 is connected to the associated winding 11 via the lying parts 16. When applied, the clamping member 10 protrudes at the position of the transition between the lying parts 16 and the connecting part 12 through the opening 3c of the carrier belt 2, and the clamping member 10 further protrudes at the position of the transition between the lying parts 14 and the wire ends 13 through the vertical slotted holes 3g and 3h of the carrier belt 2. The connecting part 12 lies against the rear side of the carrier belt 2, while the windings 11 lie against the front side of the carrier belt 2. The wire ends 13 are biased toward the carrier belt 2 in the direction of arrow 17. In order to create space on the inner side of the wire ends 13 to enable clamping of a strip-like element therein, a force 18 can be exerted on a standing part 15 as shown in FIG. 2.

The clamping member 20 has a structure similar to that of the clamping member 10, i.e. with spiral-shaped windings 21, connecting part 22, wire ends 23, lying parts 24, 26 and standing part 25. The clamping member 20 protrudes through opening 3d at the position of the transition between the connecting part 22 and lying parts 26 and through vertical slotted holes 3g and 3h at the position of the transitions between the wire ends 23 and lying parts 24. The windings 21 lie against the front side of the carrier belt 2. Due to their own resilience the wire ends 23 lie against the carrier belt 2, more specifically in this case against the downward protruding parts 9 thereof.

The clamping members 10 and 20 differ from each other in that the windings 21 are provided within the width of the connecting part 22, while the windings 11 are on the other hand provided on the outer side of the connecting part 12. The standing parts 25 further connect to the (inner) sides of the windings 21 facing toward each other, while on the other hand the standing parts 15 connect to the (outer) sides of the windings 11 facing away from each other. Another difference between the clamping members 10 and 20 is that the lying parts 24 take a right-angled form, while the lying parts 14 are straight. The right-angled form of the lying part 24 is defined by a first right-angled part 24a and a second right-angled part 24b. The first right-angled part 24a extends parallel to the lying part 14 (substantially) perpendicularly of the carrier belt 2 and connects to the wire end 23. The second right-angled part 24b extends parallel to the longitudinal direction of the carrier belt 2 and connects to the standing part 25. It is further the case that the wire from which the clamping member 20 is manufactured has a smaller diameter than the wire from which the clamping member 10 is manufactured.

Provided per slotted hole 3g, 3h is a pair of a wire outer end 13 associated with a clamping member 10 and a wire end 23 associated with clamping member 20. These wire ends 13, 23 lie directly opposite each other and, in the situation according to FIG. 2 in which clamping does not take place, enclose a downward directed angle of 10 degrees. The wire end 23 is provided here between a wire end 13 and the rear side of the carrier belt 2 at the position of a protruding part 9 thereof.

During use clamping of a strip-like element to be treated takes place by exerting a force on the standing parts 15, whereby the wire ends 13 move away from the carrier belt 2 counter to the spring action of the clamping member 10. In a manner as also already disclosed in EP 382 283 A1 (the upper edge of) a strip-like element can then be positioned between the wire ends 13 and 23 lying opposite each other, after which the force 18 is removed and the wire ends 13 move back again in the direction of the carrier belt 2 with strip-like element being clampingly received between the wire ends 13 and 23. Because of the round cross-section of the wires from which the clamping members 10, 20 are manufactured, there is a line contact, or point contact, between the wire ends 13, 23 on the one hand and the strip-like element on the other, whereby only a minimal part of the surface of the strip-like element is covered/masked as a result of the clamping.

FIGS. 4a to 7 relate to a second embodiment of a transport member 51. A strip-like element 52 to be treated in a bath is also shown in FIGS. 4a, 4b and 7. The strip-like element 52 is mirror-symmetrical relative to a horizontal plane of symmetry through line 53. The strip-like element 52 is a punched and shaped, for instance folded or milled, frame of electrically conductive material on which determined parts with electronic components are encapsulated in applied plastic protective layers 54 provided in two opposite rows. On the outer side of each of the protective layers 54 the strip-like element 52 comprises an outward protruding part 55 with a round hole 56 therein. Adjacent protruding parts 55 are connected to each other pairwise via bridge parts 60, the centre of the width of which extends at a distance d from respectively the upper edge 57 and the lower edge 58, still just on the outer sides of the associated protective layers 54. The central part 59 of the strip-like element 52, which central part 59 extends between the two rows of protective layers 54 lying opposite each other, is in electrically conductive connection with the protruding parts 55, and thereby with the bridge parts 60.

The transport number 51 has various similarities to the transport member 1 and is described below particularly to the extent the transport number 51 differs from the transport member 1 and in the interest of a good understanding of the present invention. The transport member 51 comprises an endless carrier belt 62 having therein a regular pattern of punched openings which do or do not connect to the upper edge 65 or the lower edge 66 of the carrier belt 62. The contour of the lower edge 66 is such that the carrier belt 62 has downward protruding parts 69.

The transport member 51 further comprises clamping members 70, 80 which are mounted alternately on the carrier belt 62 in a manner similar to that in which the clamping members 10, 20 are mounted on the carrier belt 2. A further description is not therefore necessary, all the more so as FIGS. 4a, 4b and 7 are also clearly illustrative. The clamping members 70, 80 are very similar to the clamping members 10, 20. The clamping members 70, 80 differ however from the clamping members 10, 20 in that one of the wire ends of each of the clamping members 70, 80 is lengthened. The lengthened wire ends are designated with reference numerals 73b, 83b, while the other wire ends of the clamping members 70, 80, which thus have a length similar to that of the wire ends 13, 23, are designated with reference numerals 73a, 83a. The wire ends 73b, 83b are positioned opposite each other for mutual clamping co-action and, in the situation where clamping is not taking place and the wire ends 73b, 83b lie against each other, enclose a downward directed angle of 20 degrees with each other. During clamping (see FIG. 7) this angle becomes smaller, although the thickness of the strip-like element 52 at the clamping position is such that said angle will never be directed upward. The wire ends 73a, 83a are also provided opposite each other but in this embodiment do not contribute toward clamping of the strip-like element 52. The distance P between two adjacent pairs of lengthened wire ends 73b, 83b corresponds to the distance R between two adjacent bridge parts 60. The wire ends 73b, 83b extend here over a height h below the lower edge 58 of the carrier belt 62. Clamping of the strip-like element 52, more specifically at the position of the respective bridge parts 60 thereof, can hereby take place below the level of the lower edge 58. During such a clamping of the strip-like element 52 only the bridge parts 60 on the upper side of the strip-like element 52 are thus partially covered by the transport member 51. It is precisely because of the round shape of the wire from which the clamping members 70, 80 are manufactured, whereby line contact or point contact occurs between the wire ends 73b, 83b on the one hand and the bridge parts 60 on the other, that the surface of the strip-like element 52 where contact occurs is moreover minimal. Substantially the whole surface of the strip-like element 52 can thus be exposed to the treatment in the liquid in a bath. Since the upper edge 57 of the strip-like element 52 is still situated just below the lowest level of the lower edge 66 of the carrier belt 62, it is moreover not necessary during complete immersion of the strip-like element 52 for the carrier belt 62 to come into direct contact with the liquid in the bath. This can be advantageous because cleaning of the carrier belt 62 following the treatment the strip-like element 52 undergoes is hereby not necessary, or at least less necessary. The above stated angle between the wire ends 73b, 83b in combination with the engagement at the position of the bridge parts 60, which is not visible as such in FIG. 7 but the position of which is however indicated in FIG. 7, moreover results in the outer ends of the wire ends 73b, 83b protruding into the space under the bridge parts 60, whereby a highly reliable clamping is obtained.

FIGS. 8 to 10 relate to a third embodiment of a transport member 101 comprising carrier belt 104 with clamping members 110. The strip-like element 102 is clamped between the wire ends 107 of the clamping members 110 and the carrier belt 104 just below the lower edge 106 of the carrier belt 104 at the position of a downward protruding part 109 thereof. This results in a tendency toward tilting about a tilt axis extending parallel to the longitudinal direction of the strip-like element 102. The strip-like element 102, which can be guided through a bath using the transport member 101, comprises on the upper and lower sides mirror-symmetrical rows of dielectric plastic encapsulated parts 103. The two rows of dielectric parts 103 are mutually connected via the middle part 105 which is manufactured at least partially from electrically conductive material. The middle part 105 is intended for treatment in a bath.

For the purpose of treatment, in particular electrochemical treatment, of the strip-like element 102 in a bath it is necessary for an electrical voltage to be applied to the middle part 105 of the strip-like element 102. The engagement of the strip-like element 102 by clamping of the upper encapsulated parts 103 between the wire ends 107 of the clamping member 110 and the carrier belt 104 does not, because of the dielectric character of the parts 103, provide the option of applying electrical voltage via the clamping member 110 to the electrically conductive middle part 105 of the strip-like element 102. The transport member 101 therefore also comprises contact members 120 between adjacent clamping members 110. The contact members 120 are likewise embodied as wire spring and are attached due to their own resilience to the carrier belt 104 of the transport member 101. The contact member 120 has a lengthened arm 121 which runs along the upper row of encapsulated parts 103 and has a wire end 122 which makes contact under spring tension with the electrically conductive middle part 105 of the strip-like element 102. The spring tension prevents the above-mentioned tendency toward tilting. The electrical voltage necessary to allow determined electrochemical processes to take place can thus be transmitted via the contact member 120, and more specifically via the wire ends 122, to the strip-like element 102.

1-9. (canceled)

10. A transport member for transporting strip-like elements to be treated in a bath, provided with a horizontally oriented endless carrier belt with resilient wire-like clamping members attached thereto by means of their own resilience for the purpose of clamping the strip-like elements at the position of wire ends of the clamping members, wherein wire ends of adjacent clamping members are provided opposite each other for clamping the strip-like elements there between.

11. The transport member according to claim 10, wherein the carrier belt, at the lengthwise positions thereof where wire ends of adjacent clamping members are provided opposite each other, is provided with downward protruding support parts against which one of the clamping members lies due to its own resilience.

12. The transport member according to claim 10, wherein one wire end of the adjacent clamping members lies due to its own resilience against the carrier belt and the wire end of the other of the adjacent clamping members, due to its own resilience, is biased in the direction of the one wire end away from the side of the one wire end remote from the carrier belt.

13. The transport member according to claim 12, wherein the clamping member with the wire end which lies against the carrier belt is manufactured from wire with a smaller diameter than the diameter of the wire from which the other clamping member biased in the direction of the one clamping member is manufactured.

14. The transport member according to claim 10, wherein the wire ends lying opposite each other extend under the carrier belt.

15. The transport member according to claim 10, wherein the wire from which one of the two adjacent clamping members is manufactured runs between the wire end thereof and a spiral-shaped part of the clamping member partly in the longitudinal direction of the carrier belt.

16. The transport member according to claim 10, wherein at least one of the clamping members is in conductive contact with an electrical voltage source for applying an electrical voltage to the strip-like elements.

17. The transport member according to claim 10, wherein wire ends of adjacent clamping members provided opposite each other enclose a downward directed angle with each other at least in the situation where a strip-like element is not being clamped and the wire ends lie against each other in the area above the contact location.

18. The transport member according to claim 17, wherein in the situation where a strip-like element is not being clamped and the wire ends lie against each other in the area of the contact location, the size of the angle lies between 3 degrees and 30 degrees, more preferably between 5 degrees and 25 degrees.
